(19) United States
(12) Patent Application Publication
(10) Pub. No.: US 2010/0080557 A1
(43) Pub. Date: Apr. 1, 2010

(54) INTER-UNIT SETTING SYNCHRONIZATION DEVICE

(75) Inventor: Yuya ISHIDA, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/632,024

(22) Filed: Dec. 7, 2009

Related U.S. Application Data
(63) Continuation of application No. PCT/JP2007/000651, filed on Jun. 20, 2007.

(51) Int. Cl. H04J 14/02

(52) U.S. Cl. 398/48; 398/79

(57) ABSTRACT

In a transponder serving as a functional device having plural units, I/O RAM for holding functions settings contents is prepared for two sides, i.e. an ACT side and a STBY side in each unit. When functions settings contents are to be modified, the unit CPU in each unit switches the I/O RAM from the ACT side to the STBY side. The units continue to operate by using the settings contents of I/O RAM on the ACT sides, but set new settings contents for the STBY sides. The CPUs instruct that new settings contents be set simultaneously, thereby each unit reads the settings contents of I/O RAM on the STBY sides, and sets functions in the LSI.

### CROSS-REFERENCE TO RELATED APPLICATION

This application is a continuation of the PCT application PCT/JP2007/000651, filed on Jun. 20, 2007.

### FIELD

The embodiments discussed herein are related to an inter-unit setting synchronization device that synchronizes settings between units in a functional device that includes a plurality of units so as to realize a prescribed function.

### BACKGROUND

In recent years, WDM (Wavelength Division Multiplexing) transmission devices have been achieving larger capacity, ultra high transmission speeds, and higher performance, and also have been becoming more complex. Particularly, many of them have started being provided with a transmission method by which plural units are connected through mesh wiring so as to provide a cross-connect function, a Packet-SONET (Synchronous Optical Network) conversion function, an RPR (Resilient Packet Ring) function, a Protection function, etc. This has increased the number of functions involving setting information that needs to be managed and synchronized over plural units.

In the cases of a WDM function or a device (transponder unit) for converting service signals (circuits) into optical signals so that converted signals can be accommodated by WDM, an immense number (40 G, 80 G, 160 G, 320 G, or 640 G) of circuits have to be accommodated. Also, when a user has requested an increase in the number of accommodated circuits, more shelves for accommodating circuits are often used so that a Multi Shelf configuration in which plural shelves are connected to each other is employed in most cases in order to achieve a higher efficiency in cost, accommodation space, and device management.

A unit CPU, which is used for controlling all of a plurality of transponder units, has to monitor and manage, for each of plural transponders, setting changes made by a user and alarms/performance information collected from transponders.

FIG. 1 illustrates a WDM transmission device.

In FIG. 1, a transponder is illustrated as a WDM transmission device serving as a functional device. In FIG. 1, a main transponder 11 includes a plurality of units 16, and is connected to a WDM network 18. An optical MUX/DEMUX 10 is connected to the WDM network 18. Also, a sub transponder 12 is connected to the main transponder 11. Each of the units 16 in the main transponder 11 is connected to its corresponding unit 17 in the sub transponder 12 through circuits. Circuits running from a client network 15 are connected to the individual units 17 in the sub transponder 12. A unit CPU (not illustrated) is provided in the main transponder 11 and one is provided in the sub transponder 12 in order to control them. An administrator of the WDM transmission device uses a terminal device 19 connected, through a cable 13, to the unit CPU in the main transponder 11 in order to perform setting for the respective units 16 in the main transponder 11. The unit CPU in the main transponder 11 is connected to the unit CPU in the sub transponder 12 through a LAN cable 14. When an administrator desires to perform setting for the respective units in the sub transponder 12 by using the terminal device 19, instructions are transmitted to the unit CPU in the sub transponder 12 via the unit CPU in the main transponder 11. Also, the terminal device 19, the unit CPU in the main transponder 11, and the unit CPU in the sub transponder 12 each have databases for storing setting information and the like.

FIGS. 2 and 3 illustrate how settings are performed for respective units in a conventional transponder.

FIG. 2 illustrates a configuration related to setting of a function in a transponder. A shelf in one transponder includes one CPU unit 20. The CPU unit 20 includes a CPU section. This CPU section gives an instruction to set functions of units (transponder units) in each transponder. In this example, it is assumed that one transponder shelf is provided with ten transponder unit slots. Each transponder unit includes transponder common I/Os 21-1 through 21-10, transponder specific I/Os 22-1 through 22-10, RAM devices 23-1 through 23-10, Unit Firms 24-1 through 24-10, FPGAs 25-1 through 25-10, and LSIs 26-1 through 26-10. The transponder common I/Os 21-1 through 21-10 are used for receiving instructions to perform settings that are common in the transponder. Instructions are stored in the “provisioning set TRG” or the “control set TRG”, depending upon the types of instructions received. The transponder specific I/Os 22-1 through 22-10 receive instructions to perform settings that are specific to respective transponder units. The RAM devices 23-1 through 23-10 store data or the like needed for executing processes specified by instructions. The Unit Firms 24-1 through 24-10 are CPUs for controlling the LSIs 26-1 through 26-10 in order to set functions. The FPGAs 25-1 through 25-10 are software-programmable LSIs for controlling the LSIs 26-1 through 26-10 in order to set functions. The LSIs 26-1 through 26-10 receive instructions so as to set functions of actual transponder units.

FIGS. 3A and 3B illustrate sequences in a conventional function setting process.

In conventional techniques, the same methods are used for setting functions sequentially in all slots (units) in a transponder. In FIGS. 3A and 3B, the unit CPU transmits a function setting instruction to each transponder specific I/O. Next, the unit CPU transmits a function setting reflecting request to the transponder common I/Os in slot 1. The Unit Firm and the FPGA in slot 1 refer to the transponder common I/Os. When they have determined that there is a function settings reflecting request, they refer to each transponder specific I/O and read the function settings contents, set the function settings contents in the LSI, and clear the function settings reflecting request for the transponder common I/Os. The transponder common I/Os report the completion of setting to the unit CPU when the function settings reflecting request has been cleared.

The above operation is performed for all slots sequentially. In the example in FIGS. 3A and 3B, the operation is performed from slot 1 through slot 10.

As described above, in conventional techniques, a unit CPU has performed setting for transponder units in a one-by-one manner. However, in recent years, as was described above, a configuration is often employed in which units are connected by mesh wiring and a cross-connect function, Packet-SONET conversion, an RPR function, a Protection function, or the like are provided, and these functions need settings that have sequences between transponder units. Accordingly, a method by which setting is performed for each of plural transponder units one by one has been becoming useless (because processes performed by unit CPUs are becoming more complex).

In a conventional setting method for a transponder unit, when settings are performed for making plural transponder units realize one function, each of the settings is completed at a different timing, leading to temporary time differences between the times at which the respective transponder units start their operations.

Further, the increase in complexity of setting methods for transponders has increased the difficulty for unit CPUs to perform sufficient processes. Also, the increase in the number of transponder units to be managed proportionally increases loads imposed on unit CPUs, inevitably prolonging the period of processing time.

When there are differences in settings in plural transponders and databases in a configuration where databases are used for managing setting information given by a user, the unit CPUs have to calculate differences between information sets in the respective transponders and setting information in the database. This type of configuration imposes too heavy a load on those CPUs, which would be expected, and requires immense cost to be spent for a period of time used for recovering the difference and for checking the difference.

Patent Document 1 discloses a packet transfer device that synchronizes route control information of a stand-by module with an active module without requiring extremely high processing performance for a route control module.

### Patent Document 1: Japanese Laid-open Patent Publication No. 2005-303501

### SUMMARY

An inter-unit setting synchronization device according to one aspect of the present invention is an inter-unit setting synchronization device for a functional device including a plurality of functional units and controlling the plurality of functional units so as to realize a desired function, in which the functional unit includes: first and second storage units for storing functional contents to be set; a switching unit for enabling writing to either of the first and the second storage unit; and a function setting unit for newly setting a function of a functional unit of the function setting unit itself on the basis of storage contents in one of the first and the second storage units in accordance with an instruction of which the plurality of functional units are notified by the functional device in a broadcasting manner.

An inter-unit setting synchronization device for a functional device including a plurality of functional units and controlling the plurality of functional units so as to realize a desired function, in which the functional unit includes: a setting storage unit for storing functions contents to be stored; a reference stopping unit for stopping reference to the setting storage unit; a writing unit for writing new functions contents to the setting storage unit; and a function setting unit for newly setting a function of a functional unit of the function setting unit itself on the basis of storage contents in the setting storage unit in accordance with an instruction of which the plurality of functional units are notified by the functional device in a broadcasting manner, said instruction instructing that the new functions contents be reflected in an operation of the functional unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 illustrates a WDM transmission device;

FIG. 2 illustrates how settings are performed for respective units in a conventional transponder (first);

FIGS. 3A and 3B illustrate how settings are performed for respective units in a conventional transponder (second);

FIG. 4 illustrates operations of normal processing in the first embodiment of the present invention;

FIG. 5 illustrates operations in the first embodiment of the present invention (first);

FIG. 6 illustrates operations in the first embodiment of the present invention (second);

FIG. 7 illustrates operations in the first embodiment of the present invention (third);

FIG. 8 illustrates operations in the second embodiment of the present invention (first);

FIG. 9 illustrates operations in the second embodiment of the present invention (second);

FIG. 10 illustrates operations in the second embodiment of the present invention (third);

FIG. 11 illustrates operations in the second embodiment of the present invention (fourth);

FIGS. 12A and 12B illustrate the first embodiment of the present invention in more detail (first);

FIGS. 13A and 13B illustrate the first embodiment of the present invention in more detail (second);

FIGS. 14A and 14B illustrate the second embodiment of the present invention in more detail (first);

FIGS. 15A and 15B illustrate the second embodiment of the present invention in more detail (second);

FIGS. 16A through 16C illustrate an application of the present invention (first);

FIGS. 17A through 17C illustrate an application of the present invention (second);

FIGS. 18A and 18B illustrate an application of the present invention (third); and

FIGS. 19A and 19B illustrate an application of the present invention (fourth).

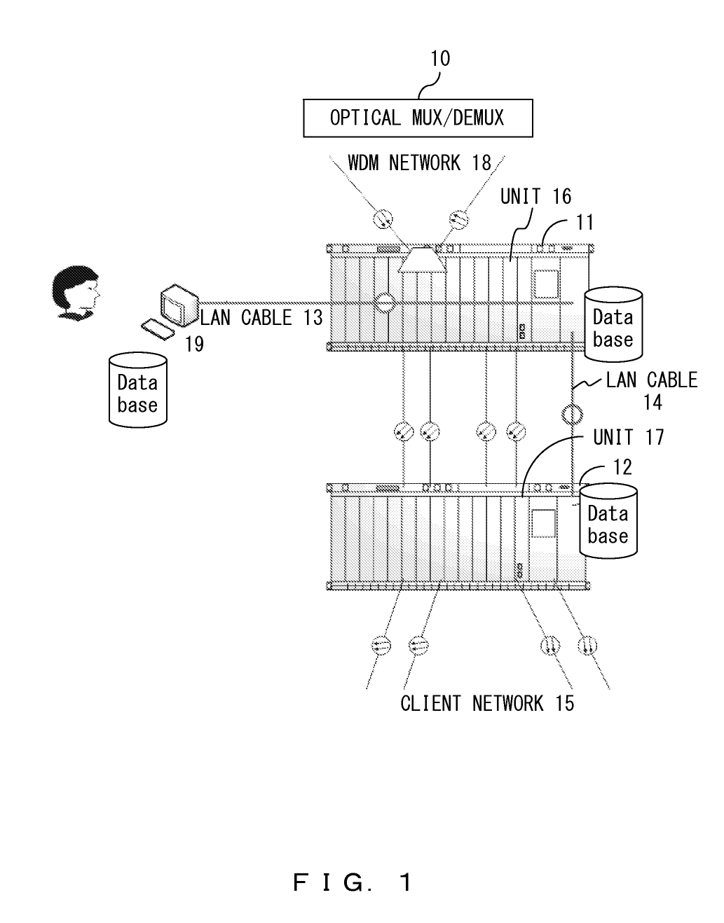

### DESCRIPTION OF EMBODIMENTS

Embodiments of the present invention provide a setting method in which steps 1-1 through 1-5 and 2-1 through 2-4 described below are performed, setting information is set in all units at once, and simultaneous setting information side switching is performed by using Broadcast SET TRG as necessary in order to eliminate the need for setting sequences.

1-1. Making each transponder unit in a Shelf manage setting information I/O RAM for two sides, i.e., ACT (active) and STBY (stand-by).
1-2. In an initial operation state, units operate using setting information I/O RAM on the ACT side. Setting information I/O RAM on the STBY side is not used for operating units, and accordingly setting information can be written without influencing operations of units such as signals to be processed.
1-3. An I/O instruction dedicated to switching sides, referred to as a SET TRG (Set Trigger), is prepared for switching to new setting information, i.e., switching between ACT and STBY.
1-4. A unit CPU is provided with a Broadcast SET TRG (simultaneous reflection instruction) in addition to a SET TRG.
1.5. Transponder units transmit a Broadcast (simultaneous) notification to unoccupied signals in the MESH wiring.

In addition to the above, the following measures are taken when the two-side management is difficult to perform due to resource problems such as in the case of ACT and STBY sides.

2-1. Freeze requests are issued to the FPGA and Unit Firm in transponder units.
2-2. An I/O instruction dedicated to a freeze request, referred to as a SET TRG (Set Trigger), is prepared for making freeze requests.
2-3. A Unit CPU is provided with a Broadcast SET TRG (simultaneous reflection instruction) in addition to a SET TRG.
2-4. Transponder units transmit a Broadcast (simultaneous) notification to unoccupied signals in the MESH wiring.

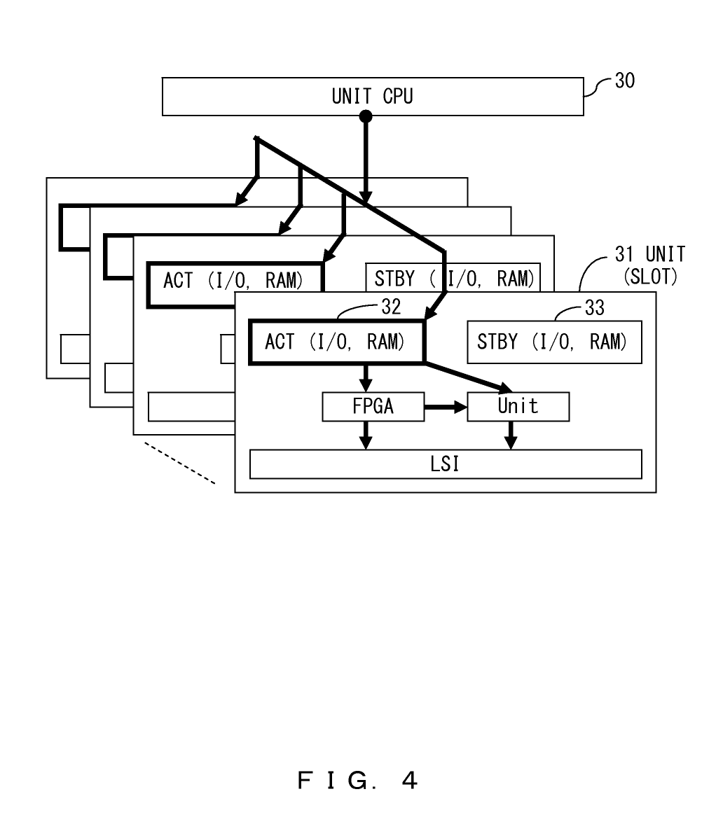

FIG. 4 illustrates operations of normal processing in the first embodiment of the present invention.

A unit CPU 30 handles plural units (slots) 31, and each unit (slot) 31 is provided with an ACT side 32 of I/O RAM, a STBY side 33 of I/O RAM, and also an FPGA, a Unit Firm, and an LSI, which operate using setting information I/O RAM similarly to conventional techniques.

In a normal process, the CPU 30 updates information in the ACT side 32 of I/O RAM, and sets the updated information in each LSI. The normal process referred to herein is, for example, a process of updating setting information for which it is not necessary to make settings effective between units at the same time.

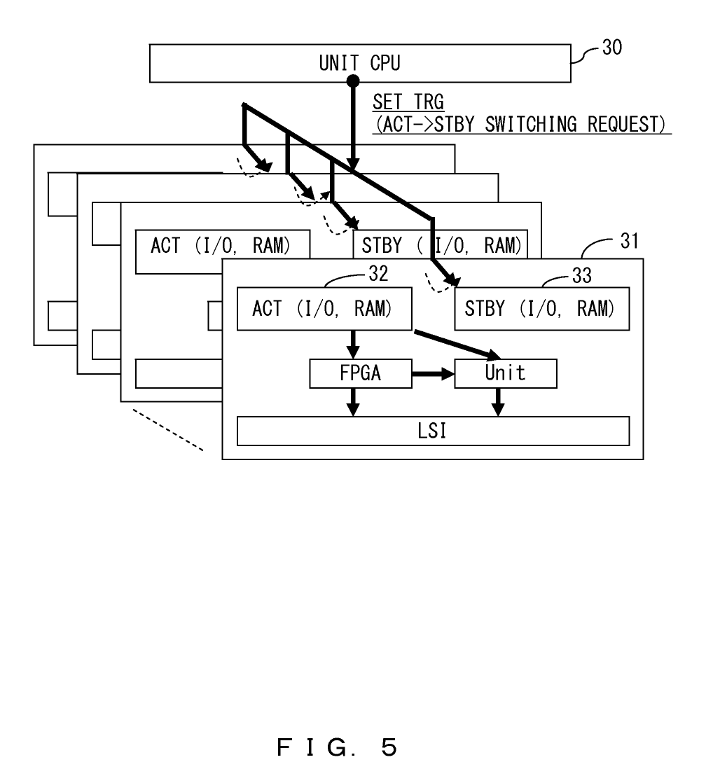

FIGS. 5 through 7 illustrate operations of the first embodiment of the present invention.

The examples illustrated in FIGS. 5 through 7 are different from the above described normal process, and are, for example, a process of updating setting information for which it is necessary to make settings effective between units at the same time.

As illustrated in FIG. 5, in response to “SET TRG” transmitted from the CPU 30, the target of I/O RAM writing is changed from the ACT sides 32 to the STBY sides 33 in all transponder units.

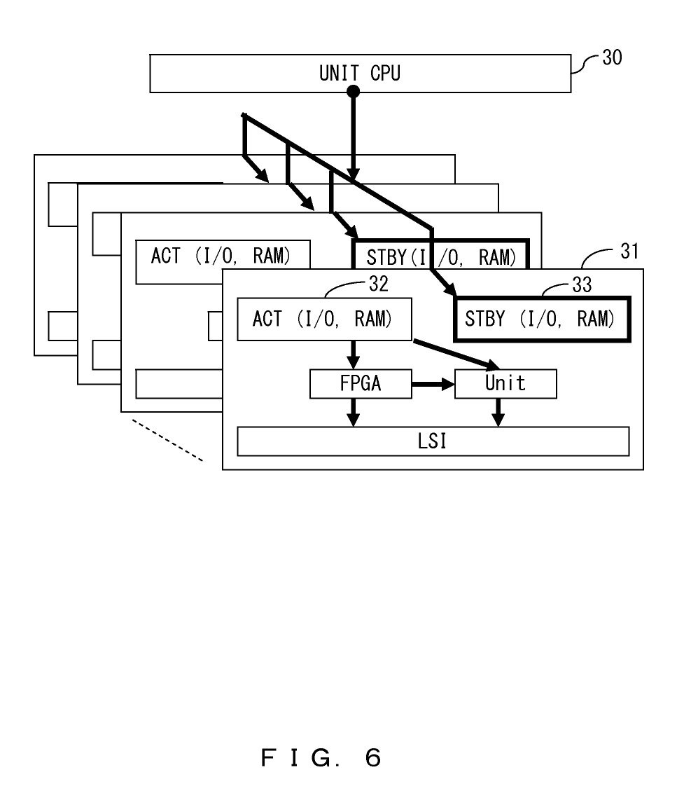

Next, as illustrated in FIG. 6, after switching the I/O RAM writing target to the STBY sides 33, the unit CPU 30 writes setting information to the STBY sides 33 of I/O RAM in all transponder units. When doing this, the transponder units are operating similarly to the previous state, i.e., in accordance with the setting information in the ACT sides 32. The only operation that the unit CPU 30 does is writing setting information to the STBY sides 33, and the unit CPU 30 does not set the information in the LSIs at this point in time.

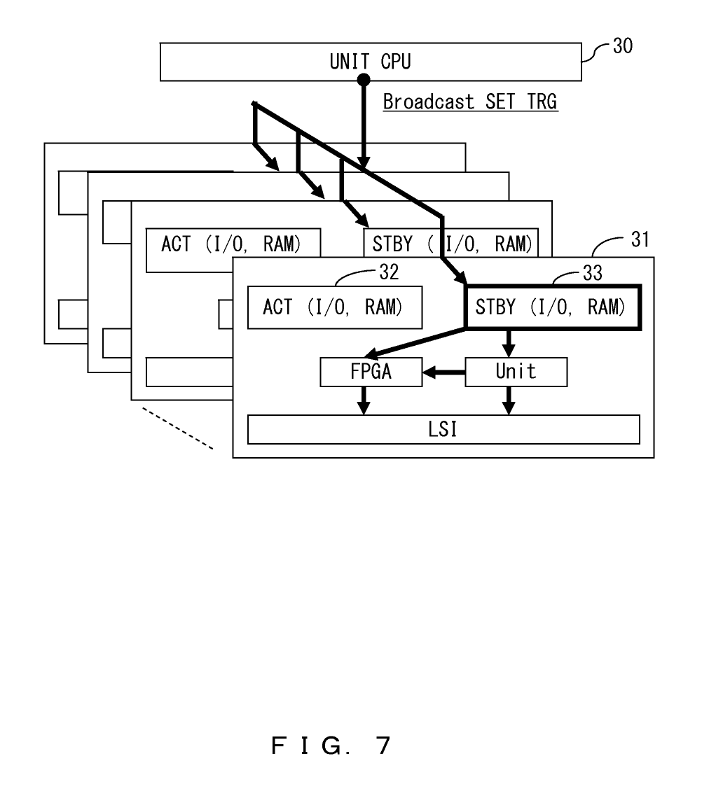

Next, as illustrated in FIG. 7, in response to a broadcast notification transmitted from the unit CPU 30, all transponder units set, in the LSIs, the setting in the STBY sides 33 in I/O RAM simultaneously.

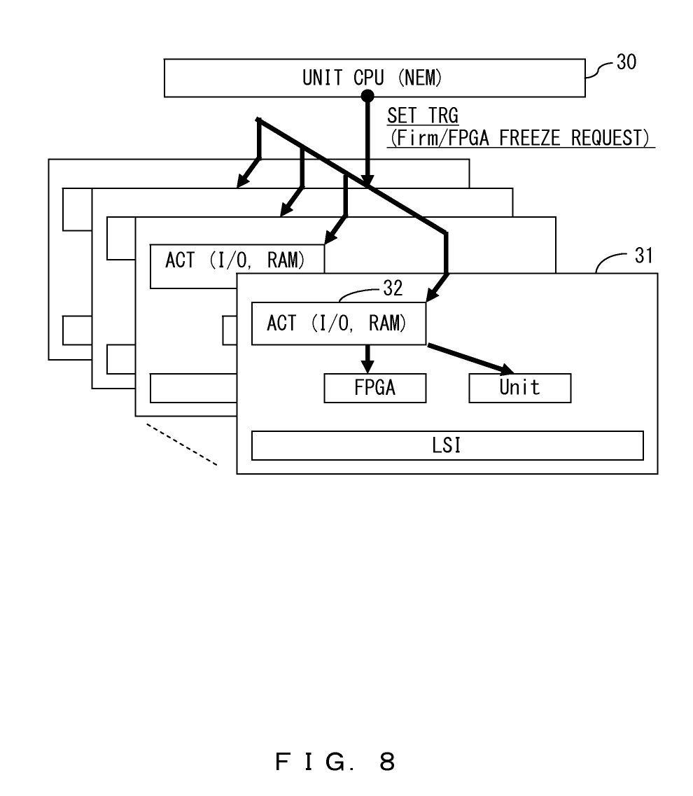

FIGS. 8 through 11 illustrate operations of a second embodiment of the present invention.

The normal process is basically the same as in the case illustrated in FIG. 4, and the only difference is that the present embodiment does not have the STBY sides 33 for the I/O RAM.

When a function setting is performed for transponder units in the present embodiment, the unit CPU 30 transmits an FPGA/Unit Firm freeze request to each unit. In other words, the unit CPU 30 makes a freeze request so that the FPGAs and the Unit Firms do not read the ACT (I/O RAM) sides 32.

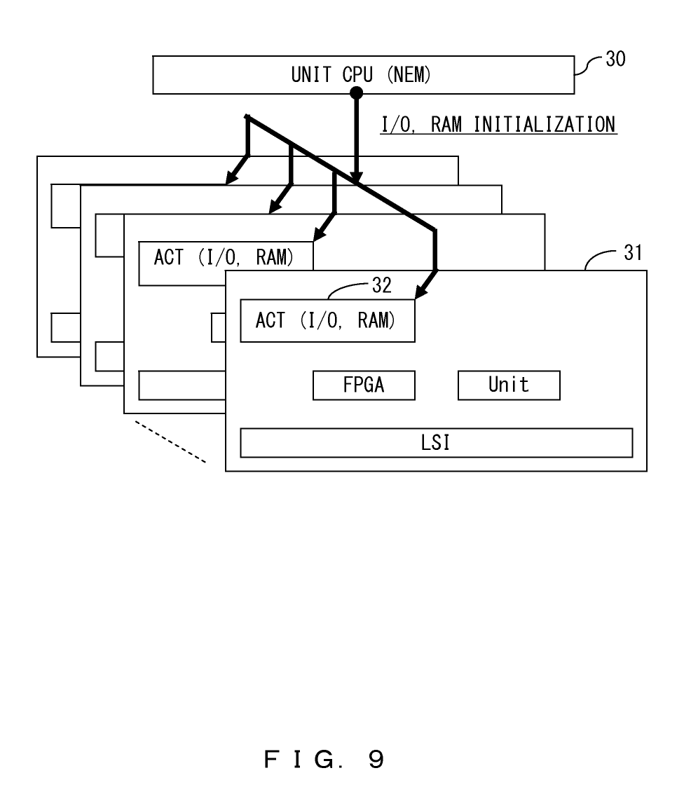

Next, as illustrated in FIG. 9, I/O RAM on the ACT sides is initialized. In other words, the setting information that has been effective until immediately before the issuance of the freeze request and has been recorded on the ACT sides of I/O RAM is cleared.

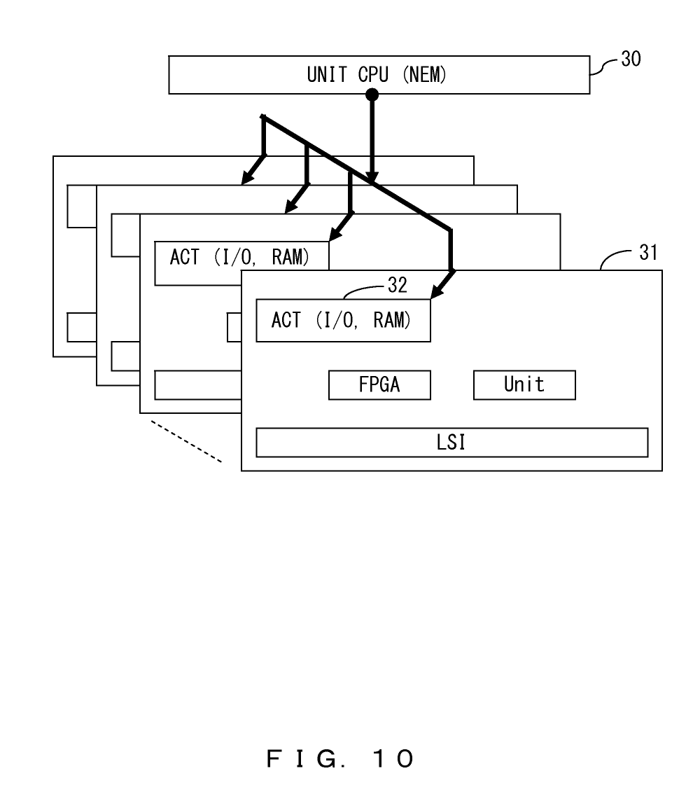

Next, as illustrated in FIG. 10, the unit CPU 30 virtually sets setting information in the ACT (I/O RAM) sides 32. (This setting is a virtual setting, and the FPGA or the Unit Firm does not read the ACT (I/O RAM) side 32.)

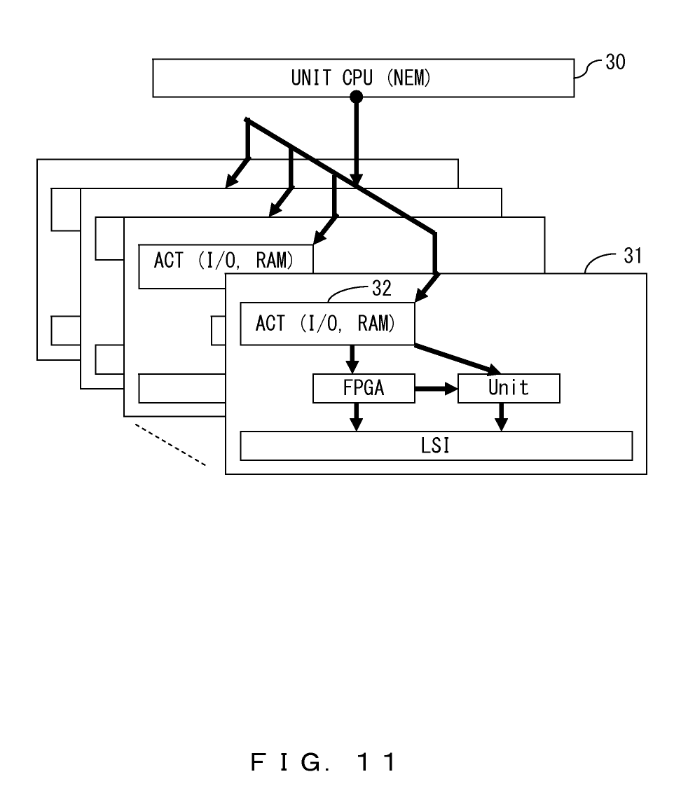

Next, as illustrated in FIG. 11, all transponder units simultaneously reflect the setting in accordance with a simultaneous reflection request based on the broadcast notification transmitted from the unit CPU 30.

Also, in the present embodiment, it is also possible to employ a configuration in which Broadcast SET/TRG, which is a setting simultaneous reflection request from the unit CPU, can be designated as a Port/Slot so that non-sequential simultaneous synchronization setting can be realized only for partial functional blocks of a unit.

Alternatively, the present embodiment can be applied in order to compensate for differences that can be made between databases of a unit CPU when such databases are made redundant.

According to the present embodiment, it is easy to perform resetting by using virtual setting information generated from the initial default state without bothered for making connections of functions between transponder units.

Also, by distributing processing to respective transponder units, it is possible to solve the problem that the limiting of a unit CPU requires a longer activation time period when a lot of setting information is to be set.

Because the unit CPU makes a request to reflect settings information at the same timing, there is only a very small influence on signal services.

Synchronization of databases and synchronization of settings information with transponders are not based on a difference but on the setting of all the information, resulting in sureness in implementation.

The use of 2-side management (ACT and STBY) and freeze requests makes it possible to modify settings information without influencing signal services so that the safety and quality of devices can be increased.

Also, virtual settings information generated from the default state of the initial value is always set by following the procedures for setting all information, eliminating the need to add new sequences such as resetting after checking differences so that bugs or problems that can be involved in sequences can be avoided in advance.

Usually, when a unit CPU performs a one-by-one setting, it issues a setting completion notification (Complete) after completing the setting for Firms/FPGAs. Thus, after the issuance of Complete, the unit CPU notifies Firms/FPGAs of the next setting. Accordingly, if the Firms/FPGAs set in ASIC or the like involve settings information for which the setting requires a waiting time period, the unit CPU has to wait for Complete for a longer time period such as that waiting time period. By contrast, the method according to the present embodiment just accesses RAM, and thus it is possible to perform a setting without being concerned with this waiting time period, so that the process can be accelerated.

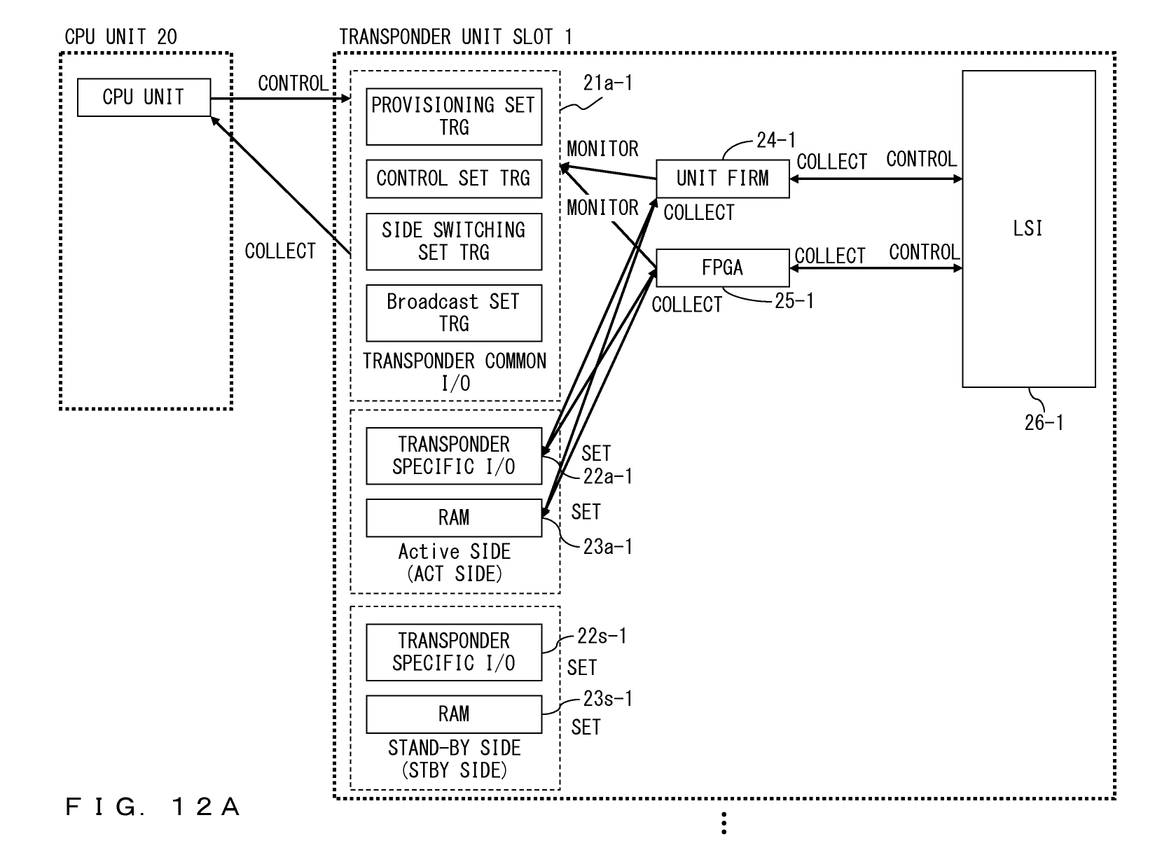

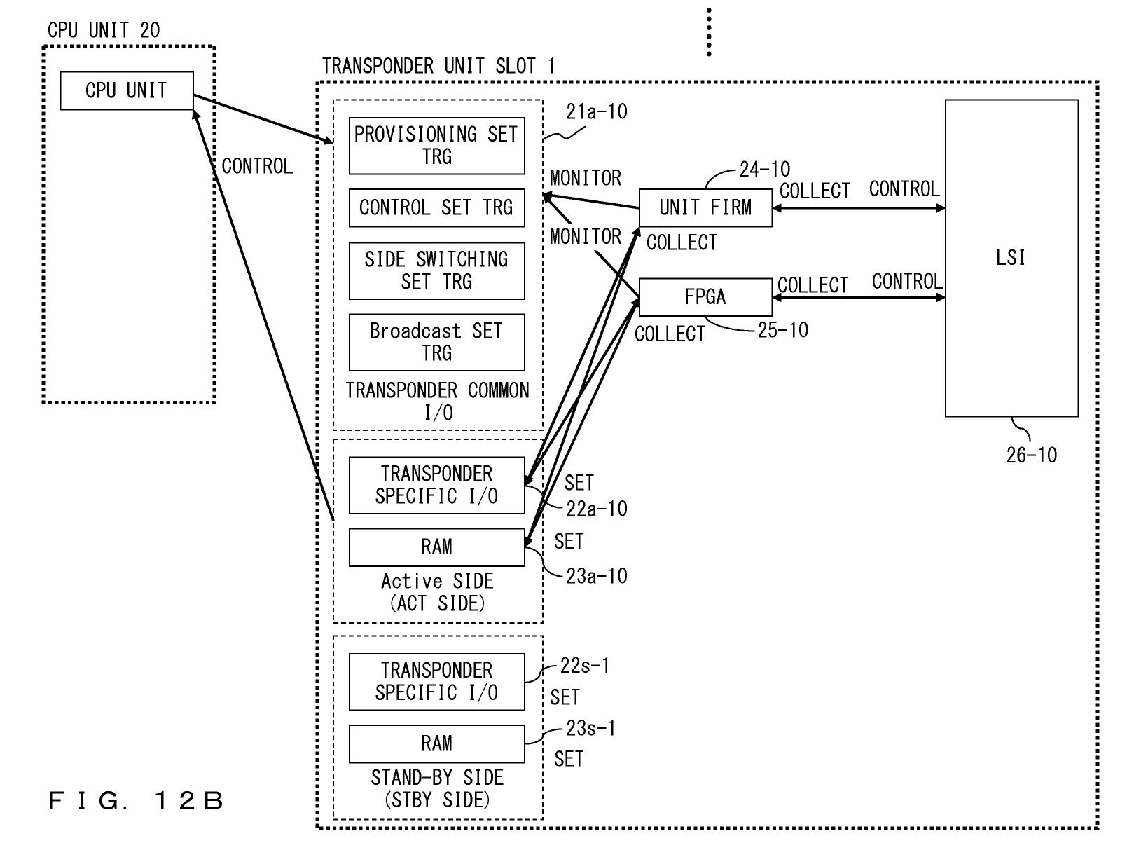

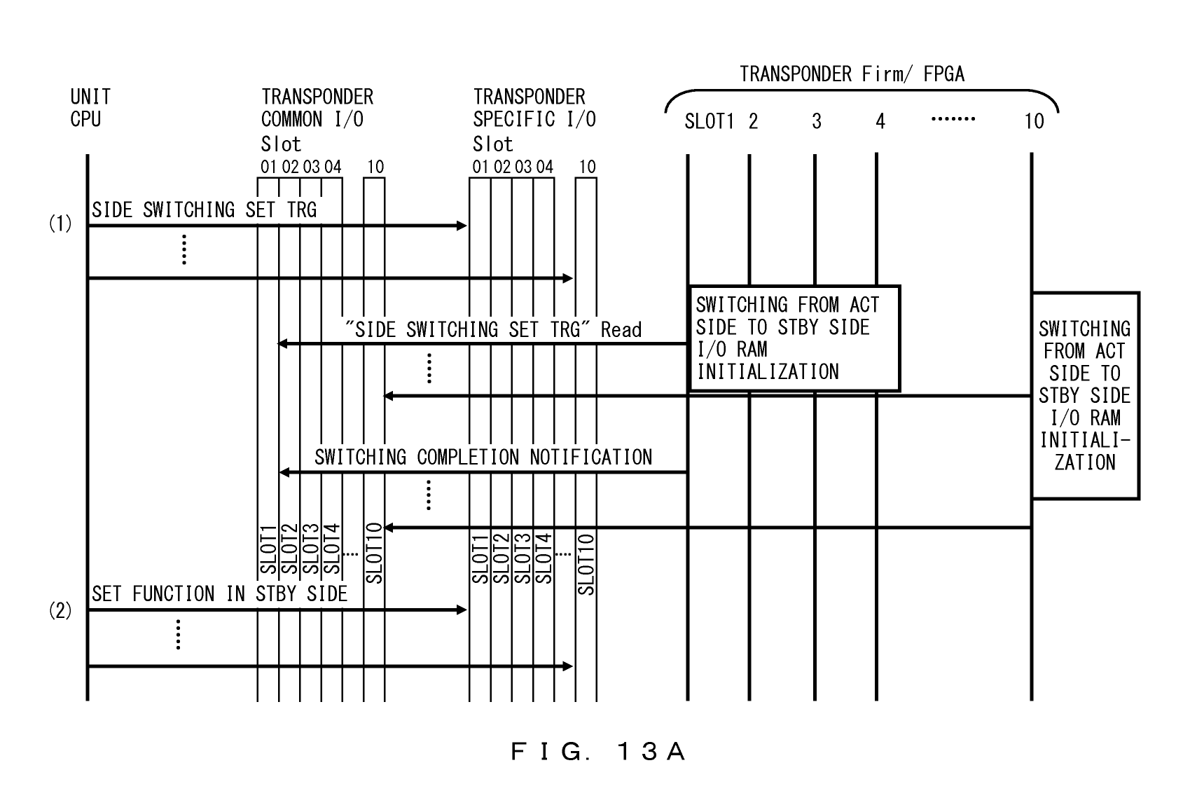

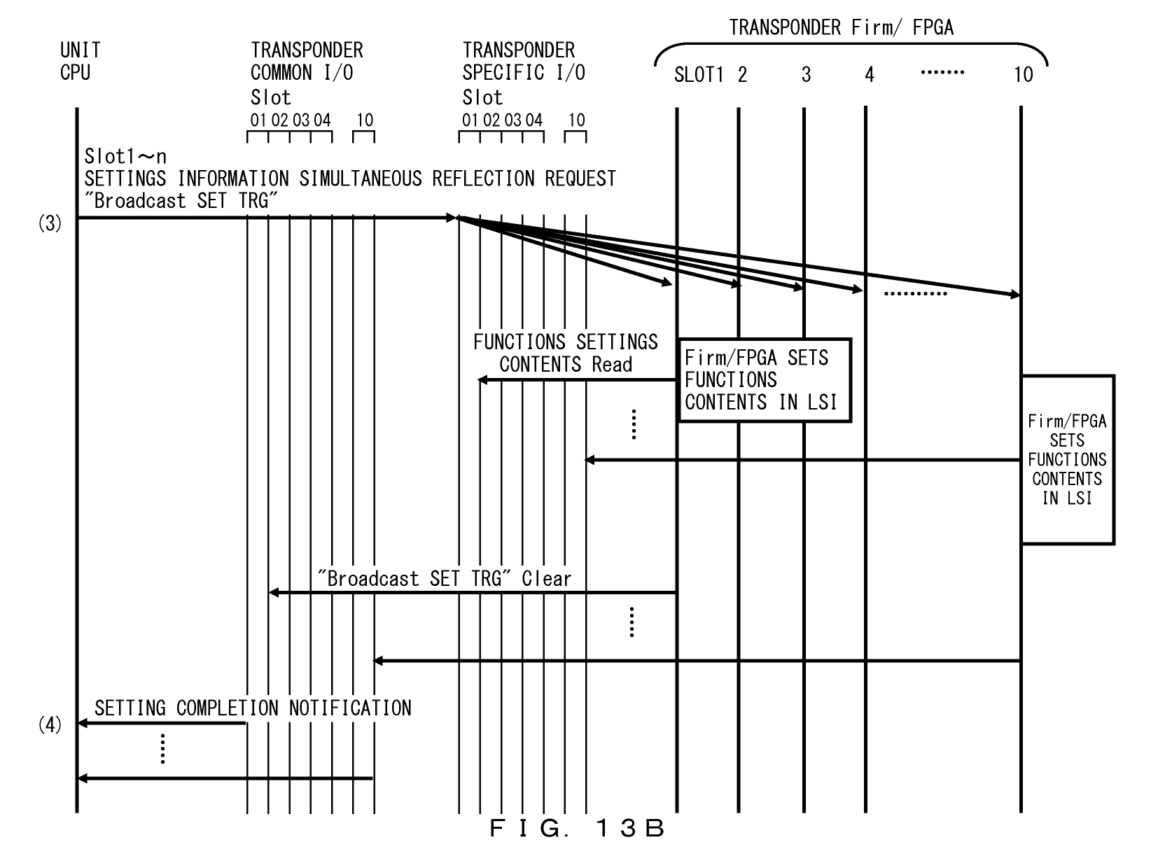

FIGS. 12A through 13B illustrate the first embodiment in more detail.

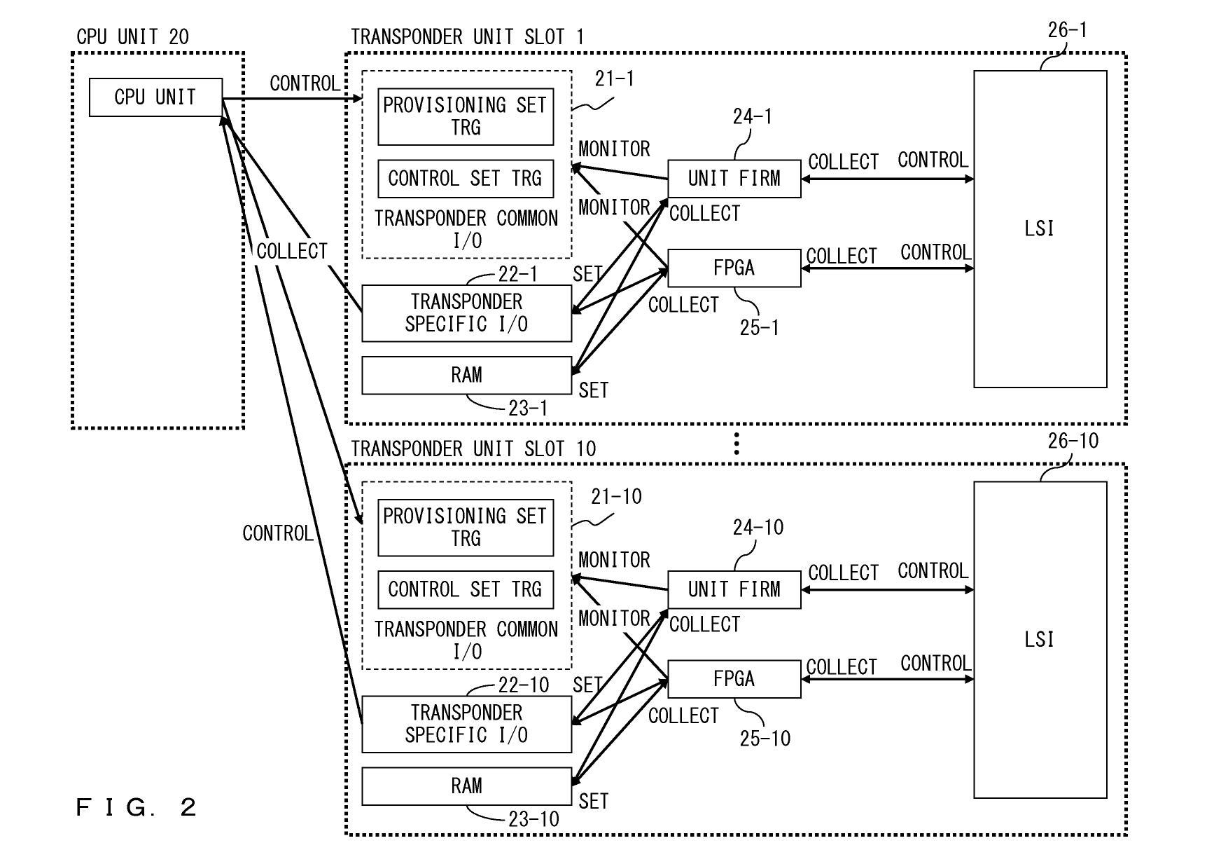

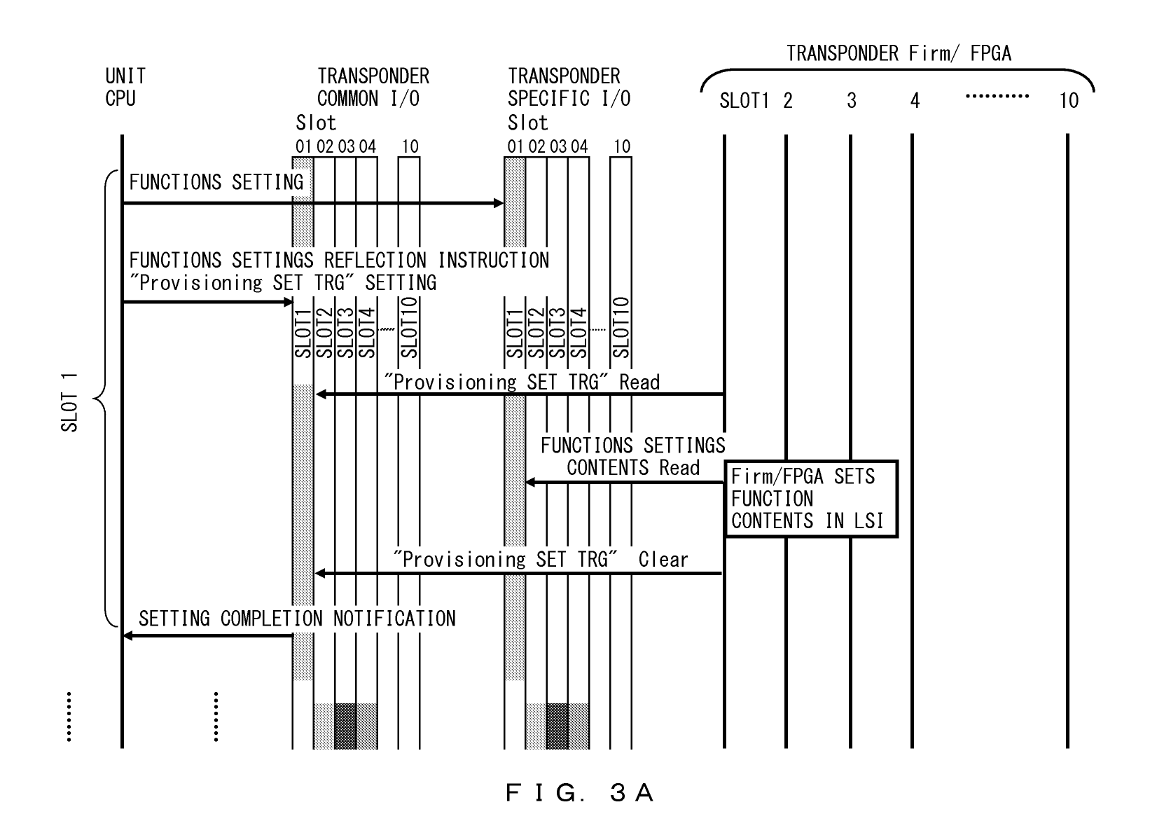

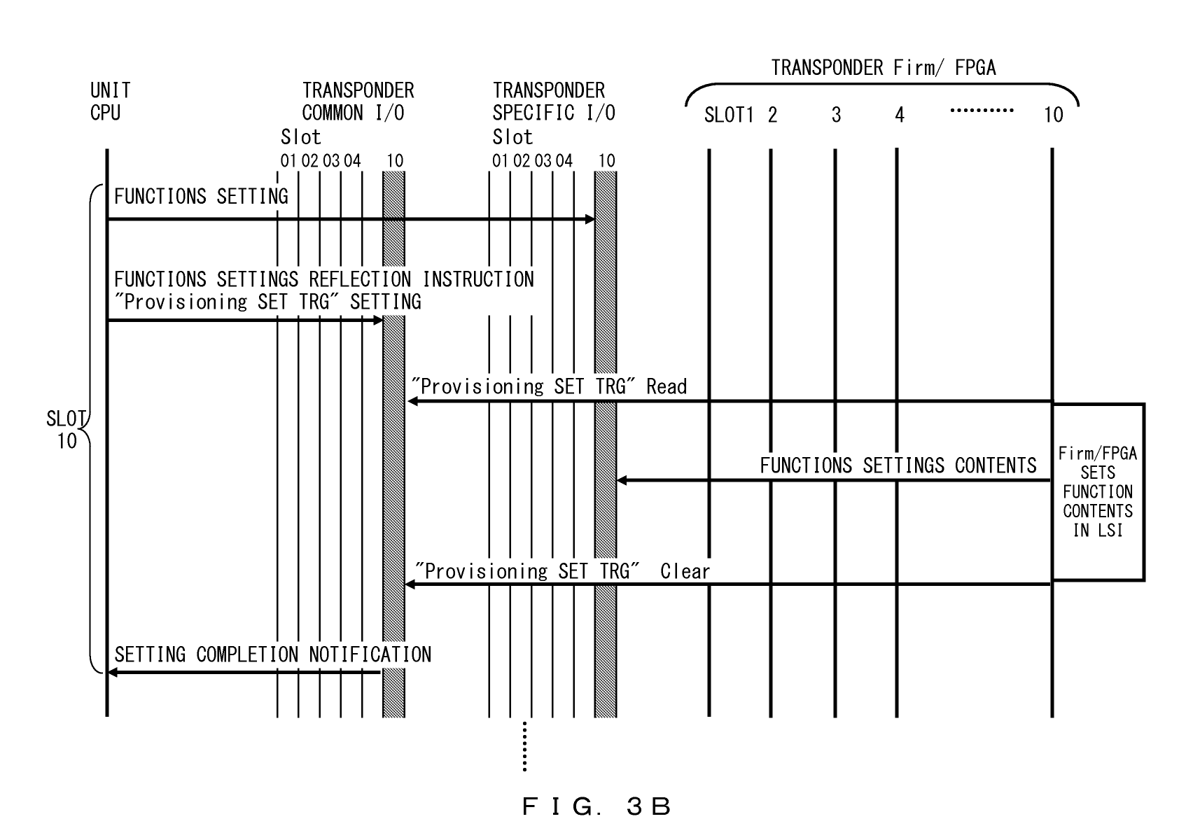

FIGS. 12A and 12B illustrate a configuration of a transponder unit. In FIGS. 12A and 12B, like constituent elements as in FIG. 2 are denoted by like numerical symbols so as to omit the explanations thereof. In the first embodiment illustrated in FIGS. 12A and 12B, transponder common I/Os 21a-1 through 21a-10 are newly provided with side switching SET TRGs and Broadcast SET TRGs. The side switching SET TRGs receive SET TRG instructions. The broadcast SET TRGs receive Broadcast SET TRG instructions. Also, in addition to transponder specific I/Os 22a-1 through 22a-10 and RAM 23a-1 through 23a-10 in the Active side, transponder specific I/Os 22s-1 through 22s-10 and RAM 23s-1 through 23s-10 in the Standby side are provided.

FIGS. 13A and 13B illustrate a sequence of operations in the first embodiment. First, the unit CPU issues, to the respective transponder specific I/Os in slots 01 through 10, a SET TRG for side switching (1). In the Firm/FPGA in each slot, the transponder specific I/O and RAM are switched from the ACT side to the STBY side in order to initialize them. When the switching is finished, a completion notification is issued from the Firm/FPGA to the transponder common I/O. Next, the unit CPU performs functions setting in the transponder specific I/O on the STBY side in each slot (2). Next, the unit CPU issues, to the transponder specific I/O in each slot, a simultaneous setting reflection request (Broadcast SET TRG) for setting information (3). Each slot that has received the simultaneous setting reflection request performs settings in the LSI on the basis of the functions settings contents that have been written to the transponder specific I/O in each STBY side. When the setting is finished, “clear” for the simultaneous setting reflection request is written to the transponder common I/O in each slot, and a setting completion notification is issued to the unit CPU (4).

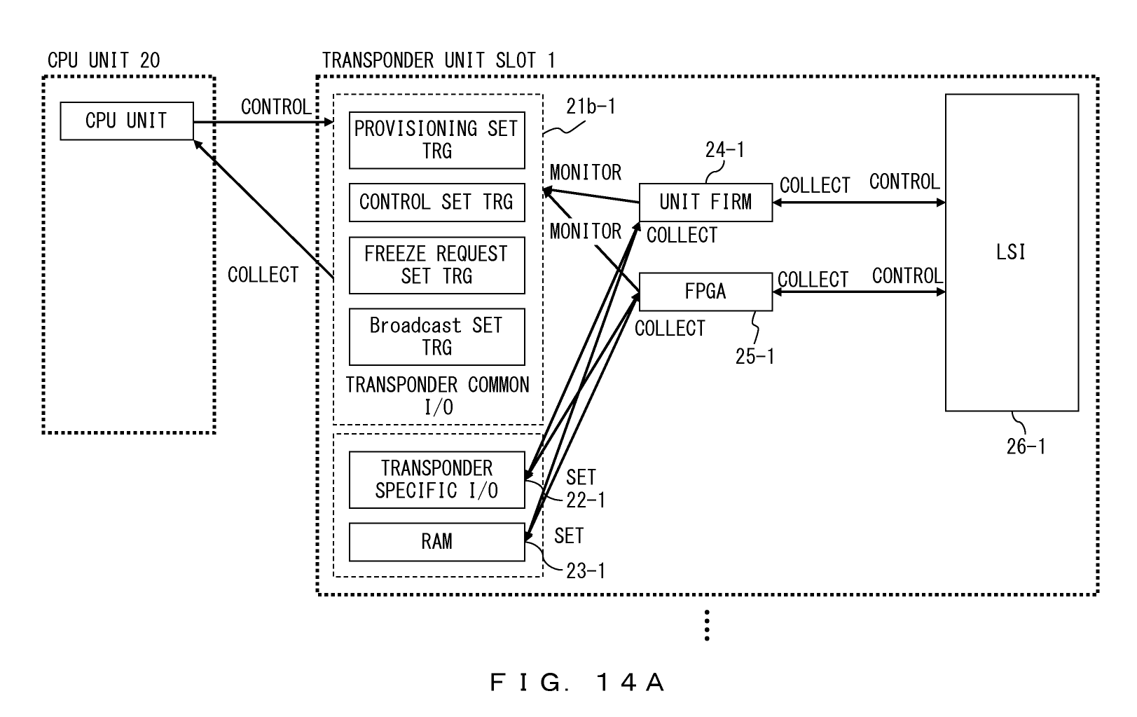

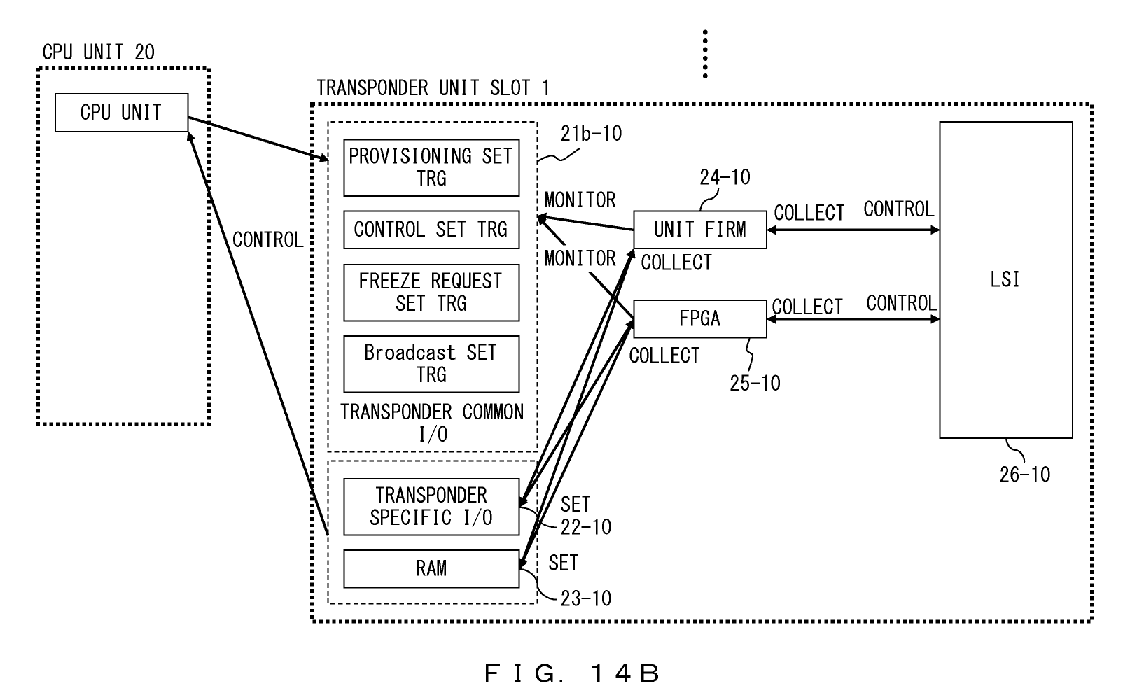

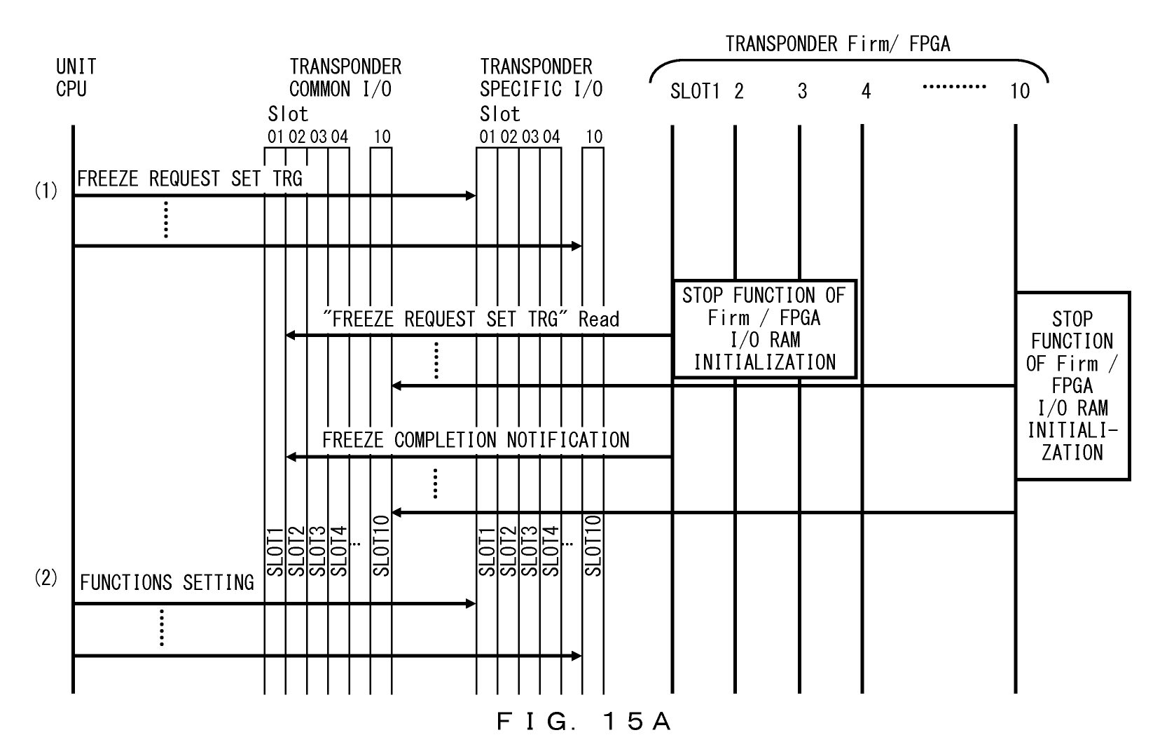

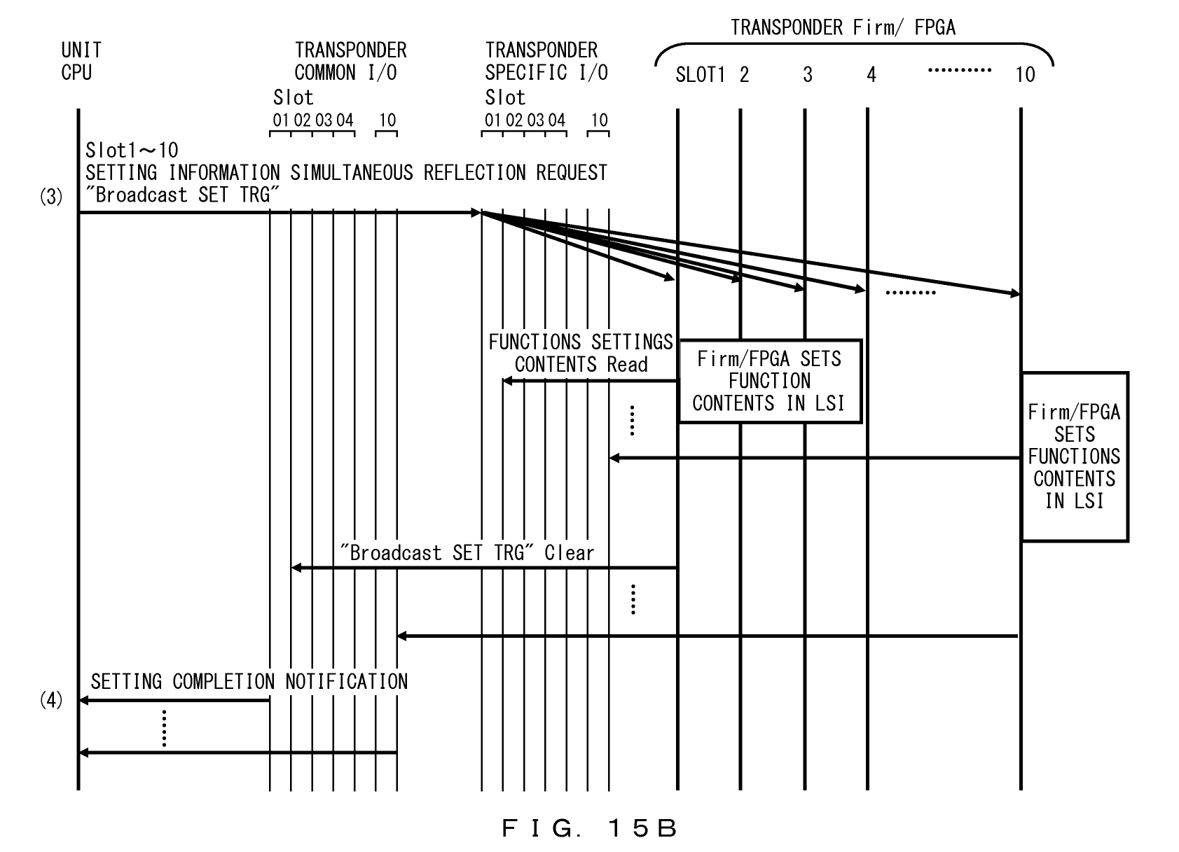

FIGS. 14A through 15B illustrate the second embodiment in more detail.

FIGS. 14A and 14B illustrate a configuration of a transponder unit. In FIGS. 14A and 14B, like constituent elements as in FIG. 2 are denoted by like numerical symbols so as to omit the explanations thereof. In the configuration illustrated in FIGS. 14A and 14B, transponder common I/Os 21b-1 through 21b-10 are newly provided with freeze request SET TRGs and Broadcast SET TRGs. In the freeze request SET TRGs, instructions are stored, which are transmitted from the CPU unit 20 and are instructing to read contents in the respective transponder specific I/Os 22-1 through 22-10 and the RAM 23-1 through 23-10 and to stop (freeze) the function of setting functions. Also, the Broadcast SET TRGs store simultaneous setting reflection requests transmitted from the CPU unit 20.

FIGS. 15A and 15B illustrate a sequence for operations in the second embodiment. First, the unit CPU writes, to the transponder specific I/O in each slot, a freeze request SET TRG (1). The Firm/FPGA in each slot, receiving the freeze request, stops its function. Also, the transponder specific I/O and the RAM are initialized. When the freezing process is completed, the Firm/FPGA notifies the transponder common I/O of the completion. Next, the unit CPU sets functions in the transponder specific I/O in each slot (2), and issues a settings information simultaneous reflection request (Broadcast SET TRG) to all slots. Thereby, the Firm/FPGA in each slot reads the functions settings contents from the transponder specific I/O in each slot and sets the functions contents in the LSI. When the functions setting is finished, the Firm/FPGA clears the setting information simultaneous reflection request, and notifies the unit CPU of the completion of the setting.

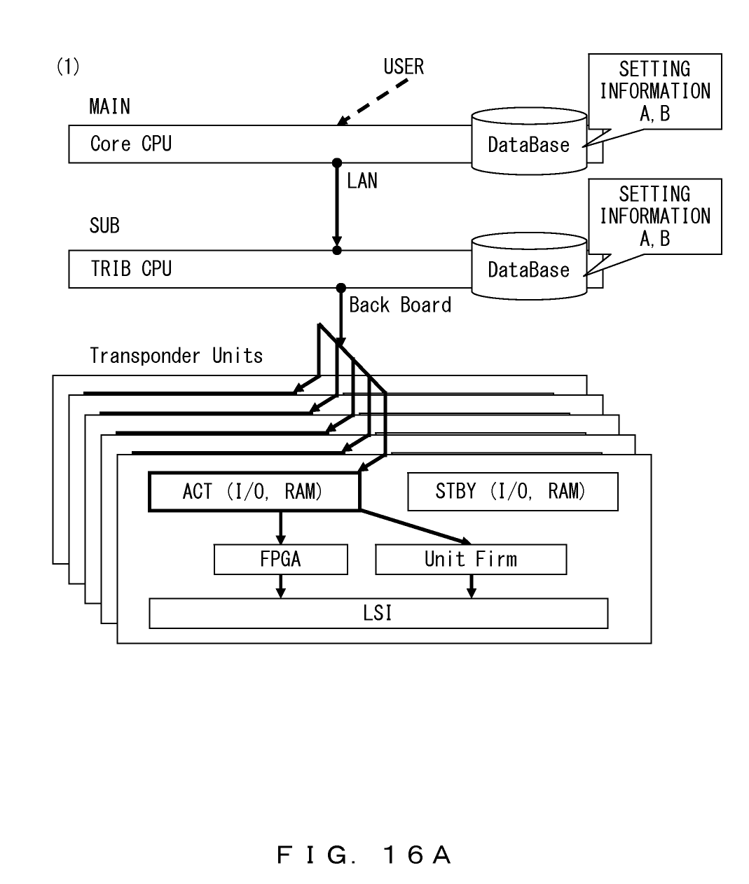

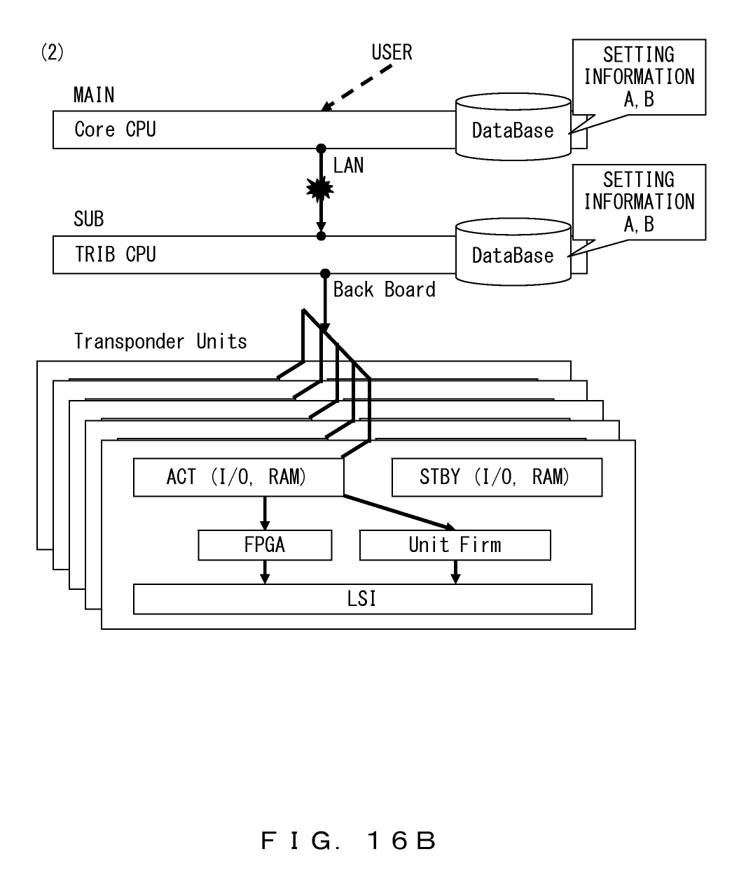

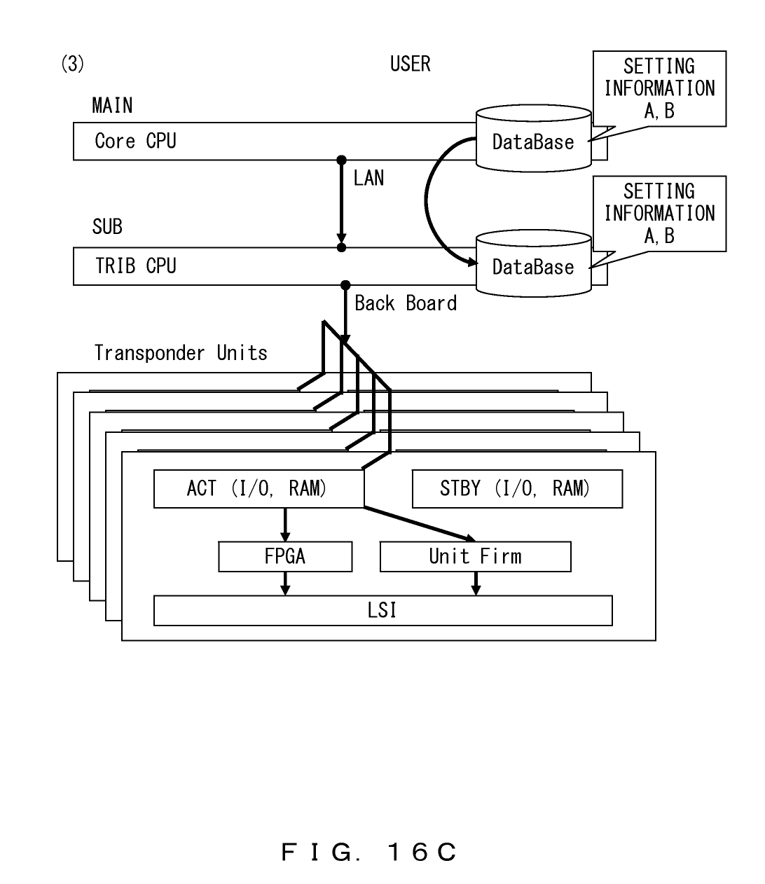

FIGS. 16A through 19B illustrate an application of the present invention.

In FIGS. 16A through 19B, “Core CPU” and “TRIB CPU” represent unit CPUs in the main transponder and the sub transponder, respectively.

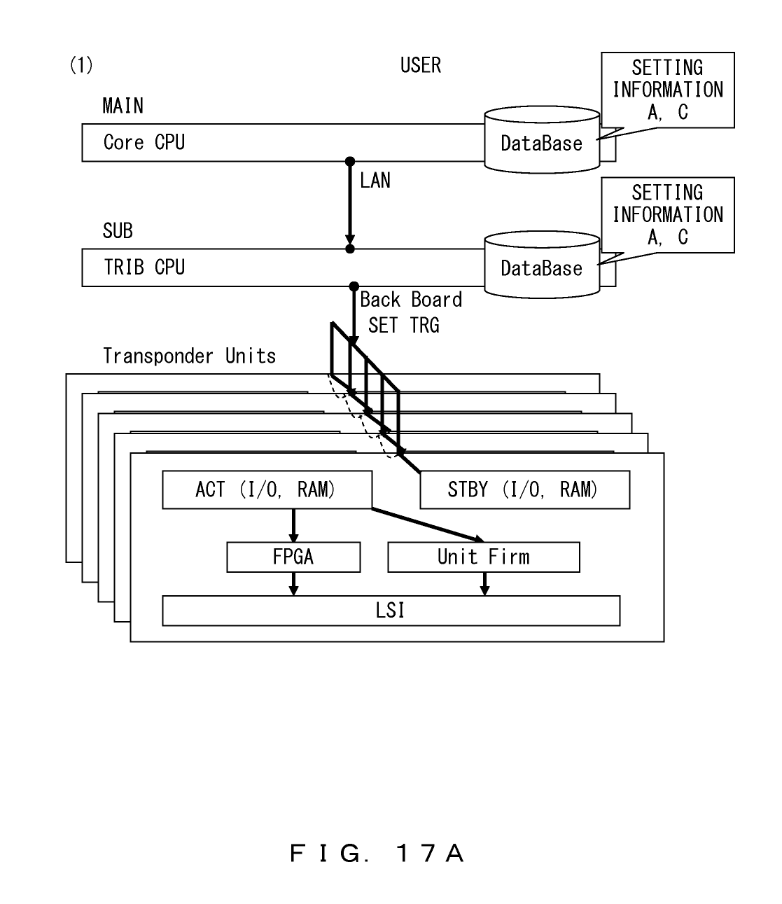

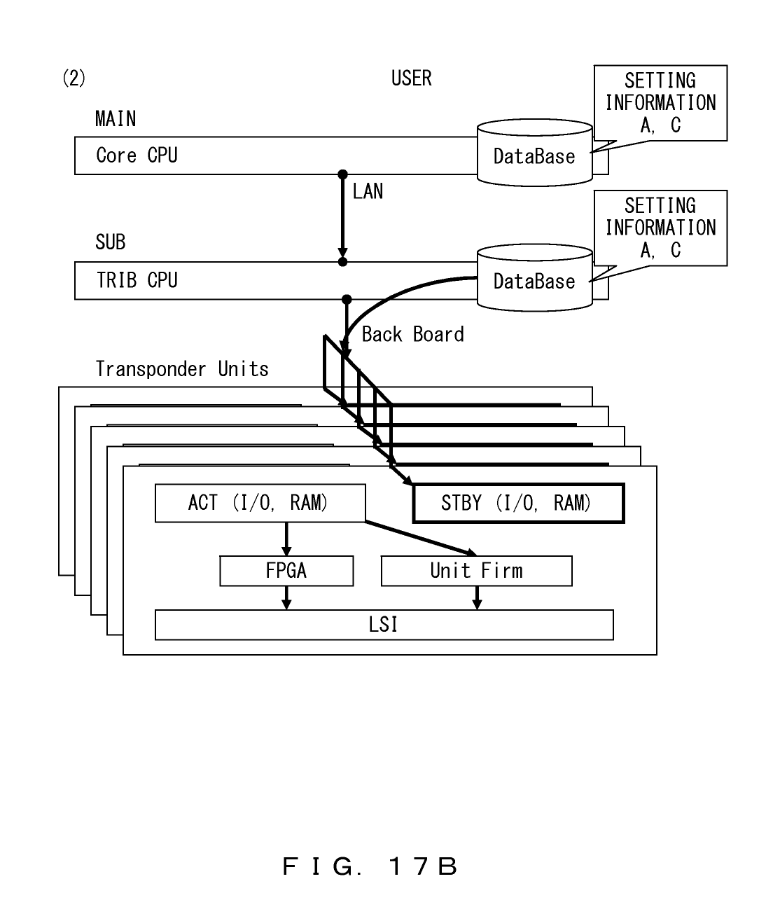

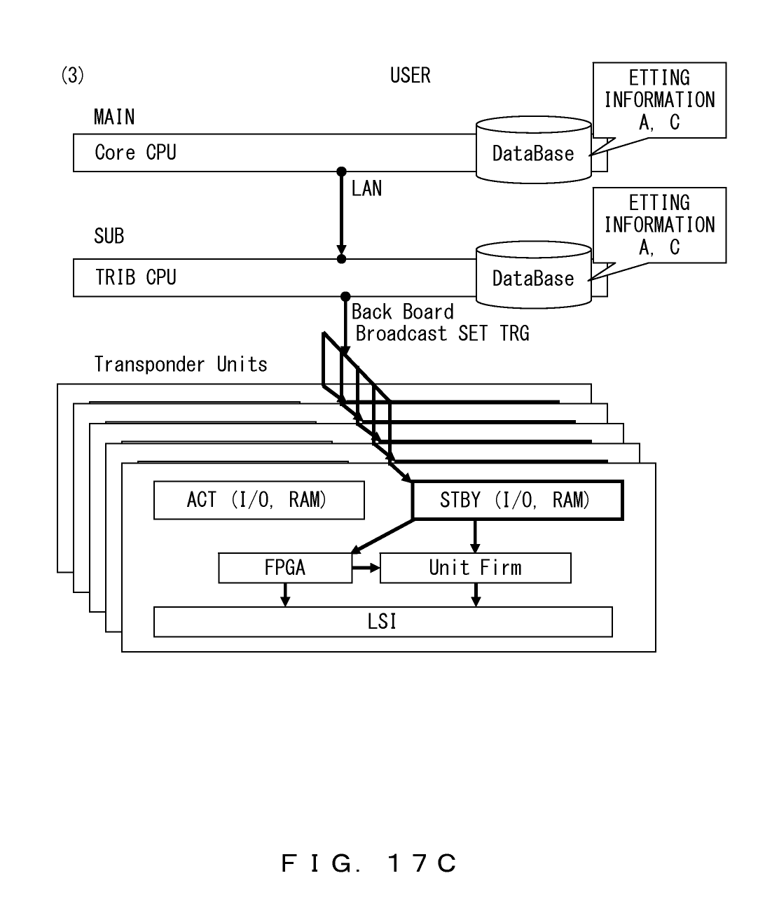

FIGS. 16A through 17C illustrate an application according to the first embodiment. In view (1) in FIG. 16A, a setting given by a user is stored in the databases in the main transponder and the sub transponder in a normal state, and their contents are in a synchronized state. Next, as illustrated in view (2) in FIG. 16B, when the LAN connecting the main transponder and the sub transponder is disconnected, the settings contents given by the user are reflected in the database in the main transponder; however, the settings contents are not reflected in the database in the sub transponder. Next, as illustrated in view (3) in FIG. 16C, when the LAN between the main transponder and the sub transponder is restored, the contents of the database in the main transponder are reflected in the database in the sub transponder. Then, a need arises to reflect, in each transponder unit, the setting contents of the database in the sub transponder.

Thus, as illustrated in view (1) in FIG. 17A, the unit CPU issues SET TRG, which is a request to switch I/O RAM from the ACT sides to the STBY sides, to the respective transponder units so that I/O RAM is switched from the ACT sides to the STBY sides. Next, as illustrated in view (2) in FIG. 17B, after switching to the STBY sides, the unit CPUs (TRIB CPUs) in sub transponder units write, to all transponder units, the settings information in the databases. Then, as illustrated in view (3) in FIG. 17C, the unit CPUs (TRIB CPUs) in sub transponder units issue broadcast notifications (broadcast SET TRG) to all transponder units so that the settings information in I/O RAM in the STBY sides is reflected simultaneously.

As described above, even when settings contents in databases in sub transponders are changed suddenly due to restoring of a LAN between main and sub transponders, new settings contents can be reflected in respective transponder units without causing abnormal operations in those transponder units.

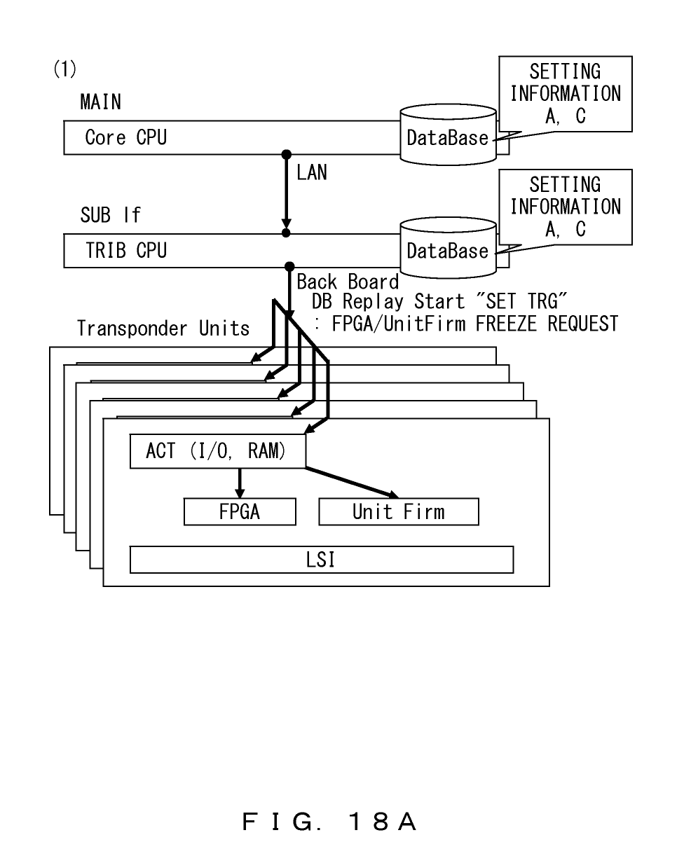

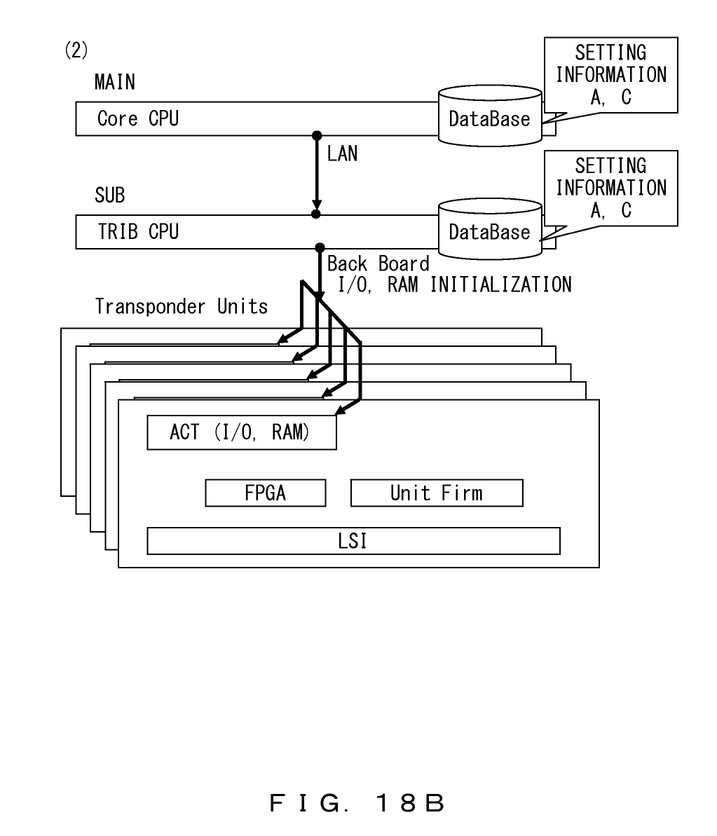

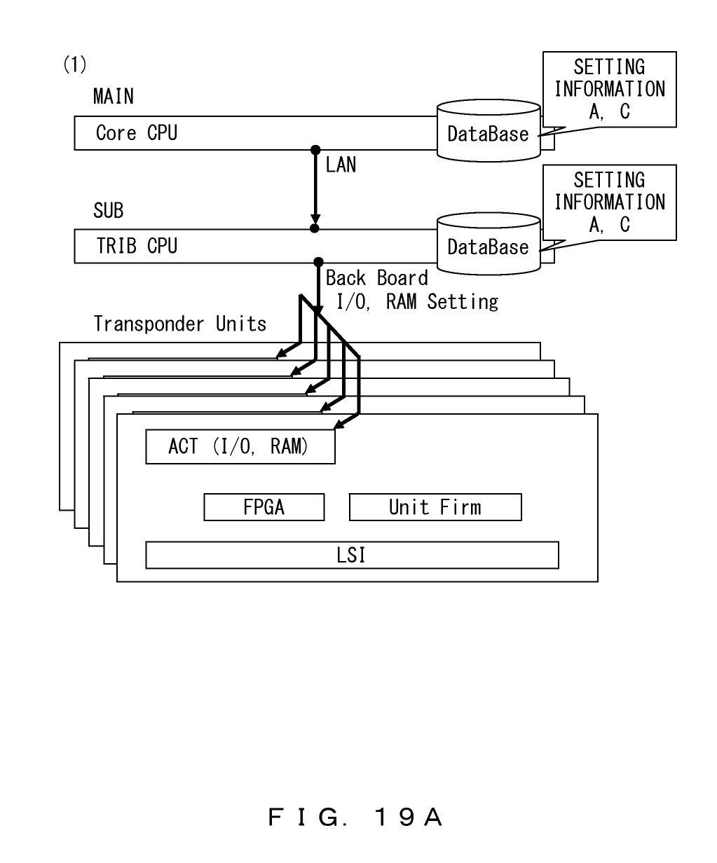

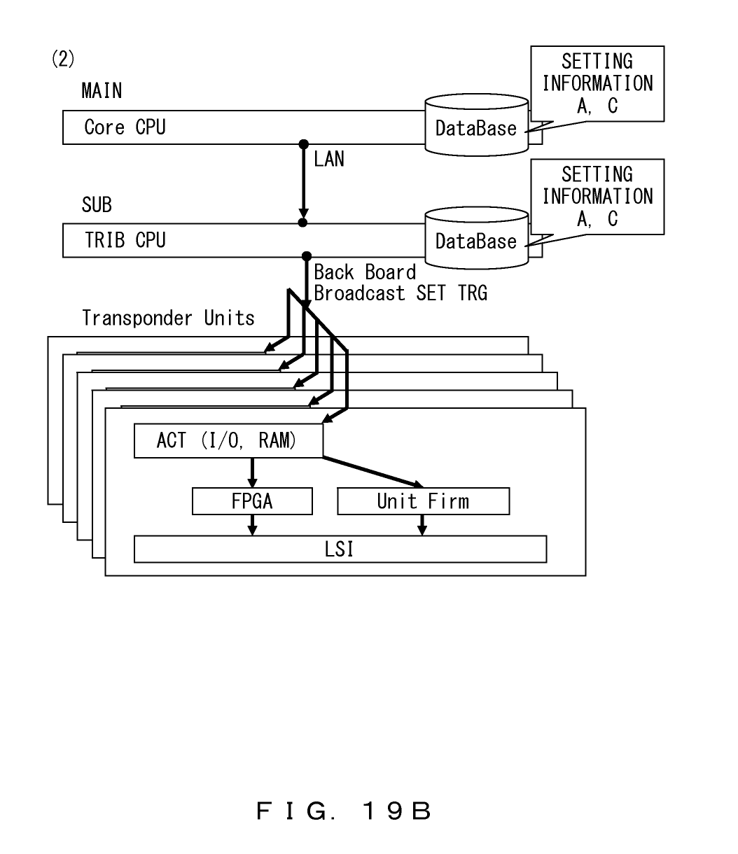

FIGS. 18 and 19 illustrate an application of the second embodiment.

FIGS. 18A and 18B illustrate a state after a LAN between main and sub transponders has been restored and the databases of the transponders have been synchronized. First, as illustrated in view (1) in FIG. 18A, the unit CPU in the sub transponder unit issues a freeze request, and the unit Firm/FPGA issues an instruction to prohibit reading of the I/O RAM. Next, as illustrated in view (2) in FIG. 18B, I/O RAM is initialized. Thereafter, as illustrated in view (1) in FIG. 19A, the unit CPU issues a Broadcast notification to make the Unit Firm/FPGA in each transponder unit read the I/O RAM, and also makes it set functions in the LSI as in (2) of FIG. 19B.

In the first embodiment, I/O RAM has to be prepared for two sides, the ACT side and the STBY side. However, when insufficient resources prevent securing of STBY regions, issuance of a freeze request as in the second embodiment can lead to the same effect as in the first embodiment.

As described above, according to the present invention, when a connection between transponders is cut so as to cause a difference in settings between main and sub transponders and the settings contents in the main and sub transponders are to be reflected in transponder units controlled by the sub transponders after the restoring, the settings contents can be reflected rapidly without causing failures.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. An inter-unit setting synchronization device for a functional device including a plurality of functional units and controlling the plurality of functional units so as to realize a desired function, the functional unit comprising:
first and second storage units to store functional contents to be set;
a switching unit to enable writing to either of the first and second storage units; and
a function setting unit to newly set a function of a functional unit of the function setting unit itself on the basis of storage contents in one of the first and the second storage units in accordance with an instruction of which the plurality of functional units are notified by the functional device in a broadcasting manner.

2. The inter-unit setting synchronization device according to claim 1, wherein:
the functional device comprises a control unit to issue a switching instruction to the switching unit, to store new function contents in storage unit, and to issue an instruction to reflect the new function contents in an operation of the functional unit.

3. An inter-unit setting synchronization device for a functional device including a plurality of functional units and controlling the plurality of functional units so as to realize a desired function, the functional unit comprising:
a setting storage unit to store functions contents to be stored;
a reference stopping unit to stop reference to the setting storage unit;
a writing unit to write new functions contents to the setting storage unit; and
a function setting unit to newly set a function of a functional unit of the function setting unit itself on the basis of storage contents in the setting storage unit in accordance with an instruction of which the plurality of functional units are notified by the functional device in a broadcasting manner, said instruction instructing that the new functions contents be reflected in an operation of the functional unit.

4. The inter-unit setting synchronization device according to claim 3, wherein:
the functional device comprises a control unit to issue a reference stopping instruction to the reference stopping means, to store new function contents in setting storage unit, and to issue an instruction to reflect new functions contents in an operation of the functional unit.

5. An inter-unit setting synchronization device, wherein:
the inter-unit setting synchronization device employs a configuration in which two functional devices each having a functional unit in a configuration of claim 1 or claim 3 are connected via a network; and
when a network failure has caused a difference between functions contents to be set in the two functional devices, the functions contents to be set in the two functional devices are synchronized after the network failure has been recovered.

6. The inter-unit setting synchronization device according to claim 1, wherein:
the functional device is an optical transponder, and the functional unit is a unit that realizes a function of an optical transponder.

7. The inter-unit setting synchronization device according to claim 3, wherein:
the functional device is an optical transponder, and the functional unit is a unit that realizes a function of an optical transponder.
